(19) United States
(12) Patent Application Publication
(10) Pub. No.: US 2002/0173862 A1
(43) Pub. Date: Nov. 21, 2002

(54) Methods of designing optimal pid controllers

(76) Inventors: Danyang Liu, Edmonton (CA); Wuyang Liu, Nanchang (CN)

Correspondence Address: Danyang Liu, 108 10615 111 Street, Edmonton Alberta, T5H 3G1, CA

(21) Appl. No.: 10/069,364

(22) PCT Filed: Jun. 7, 2001
(86) PCT No.: PCT/IB01/01002

(30) Foreign Application Priority Data
Jun. 20, 2000 (CA) 2,311,268

(51) Int. Cl. G05B 13/02

(52) U.S. Cl. 700/42

(57) ABSTRACT

Methods of designing the structure of multiple-input multiple-output (MIMO) PID controllers and methods of finding the optimal values for the MIMO PID parameters are disclosed. The optimal values of MIMO PID parameters are obtained by using an optimization algorithm which minimizes the largest modulus of all poles or the discrete time closed loop transfer function from set point SP to process variable PV, with or without user prescribed constraints on the PID parameters. Methods of designing the structure of single-input single-output (SISO) PID controllers and methods of finding tile optimal values for SISO PID parameters are also disclosed as special MIMO PID controller cases.

### TECHNICAL FIELD OF THE INVENTION

This invention relates to the design of the structure of a multivariable PID controller and the optimal choice of its PID parameters.

### BACKGROUND OF THE INVENTION

A traditional PID controller is used to control an industrial process. The process variable (PV) goes into the PLD controller, which calculates the controller output (CO) according to a PID control equation. This CO is then converted to an analog signal, which is sent to the process so that the said PV can track a user specified value called set point (SP). The said SP can change with time. The performance of a PID controller depends on the choice of its three PID parameters. For independent form of PID controllers these three PID parameters are the proportional gain Kp, the integral gain Ki, and the derivative gain Kd. For dependent form of PID controllers these three PID parameters are the gain K, integral time Ti, and derivative time Td. In traditional PID controllers the said PV, SP, CO, and PED parameters are all scalars. We call this kind of PID controllers the single-input single-output (SISO) PID controllers. The Ziegler-Nichols PID controller tuning method is the major one of the many methods for finding the values of PID parameters.

### DETAILED DESCRIPTION OF THE INVENTION

In this invention the SISO PID controller is extended to the multiple-input multiple-output (MIMO) PID controller that has n process variables PV1, PV2, . . . , and PVn and m controller outputs CO1, CO2, . . . , and COm, where m and n are positive integers, Corresponding to PV1, PV2, . . . , and PVn there are n set points SP1 , SP2, . . . , and SPn. In this case PV becomes a vector with PV1, PV2, . . . , and PVn being its first, second, . . . , and n-th component, CO becomes a vector with CO1, CO2, . . . , and COm being its first, second, . . . , and m-th component, SP becomes a vector with SPI, SP2, . . . , and SPn being its first, second, . . . , and n-th component, and the PID control equation becomes CO(k)=CO(k−1)+K1*SP(k)*T+K1*a(k,1)+K2*a(k,2) +. . . +Kj*a(k,j), where k is the discrete time, T is the sampling period, j is a positive integer, K1, K2, . . . , Kj are m by n PID parameters, a(k,1)=[−PV(k)]*T, and a(k,j)=[a(k,j−1)−a(k−1 j−1)]/T for j> or=2. It is important to note that

1. an MIMO PID controller is able to take into account the interaction among the n process variables and m controller outputs, which can not be achieved by simply applying SISO PID controllers to each of the n process variables, and

2. there is no set point in any of a(k,1), a(k,2), . . . , and a(kj), which can avoid the unwanted sudden change in CO when SP changes with time.

The next problem of designing the optimal PID controller is to find the best values for the PID parameters K1, K2, . . . , and Kj. An optimization based method for solving this problem consists of the following four steps:

1. Convert the PID control equation into discrete time form if it is not in discrete time form.

2. Build a discrete time linear model for the process that is to be controlled by the said PID controller.

3. Form the discrete time closed loop transfer function from said vector SP to said vector PV.

4. Find the best PID parameters by using an optimization algorithm which minimizes the largest modulus of all poles of the discrete time closed loop transfer function obtained at step 3, where the modulus of a pole is defined to be the absolute value of the complex number which represents the pole. If the PID parameters are subject to some constraints, then a constrained optimization algorithm can be used which minimizes the largest modulus of all poles of the discrete time closed loop transfer function obtained at step 3 and at the same time guarantees that all user prescribed constraints on the PID parameters are satisfied.

PID controllers with their parameters so obtained guarantee that PV can track SP quickly.

I claim:

1. A MIMO (multiple-input multiple-output) PID controller which has
an n-dimensional process variable vector PV with the n process variables PV1, PV2, . . . , and PVn being its first, second, . . . , and n-th component,
an n-dimensional set point vector SP with the n set points SP1, SP2, . . . , and SPn being its first, second, . . . , and n-th component, and
an m-dimensional controller output vector CO with the m controller outputs CO1, CO2, . . . , and COm being its first, second, . . . , and m-th component,
where m and n are positive integers, and in which the PID control equation is CO(k)=CO(k−1)+K1*SP(k)*T+K1*a(k,1)+K2*a(k,2)+. . . +Kj*a(k,j), where k is the discrete time, T is the sampling period, j is a positive integer, K1, K2, . . . , Kj are m by n PID parameters, a(k,1)=[−PV(k)]*T, and a(k,j)=[a(k,j−1)−a(k−1,j−1)]/T for j> or =2.

2. An MIMO PID controller of claim 1, in which the m by n PID parameters K1, K2, . . . , and Kj are obtained by using an optimization algorithm which minimizes the largest modulus of all poles of the discrete time closed loop transfer function from said SP to said PV.

3. An MIMO PID controller of claim 2, wherein the said optimization algorithm is a constrained optimization algorithm which minimizes the largest modulus of all poles of the discrete time closed loop transfer function from said SP to said PV and at the same time guarantees that the user prescribed constraints on the PID parameters are satisfied.

4. An MIMO PID controller of claim 1, wherein some or all of the terms K2*a(k,2), K3*a(k,3), . . . , and Kj*a(k,j) that appear on the right-hand side of the PID control equation are removed, for example, a PID controller with its control equation being CO(k)=CO(k−1)+K1*SP(k)*T+K1*a(k,1)=CO(k−1) +K1*[SP(k)−PV(k)]*T, which is also called a 1-only controller, and a PID controller with its control equation being CO(k)=CO(k−1)+K1*SP(k)*T+K1*a(k,1)+K2*a(k,2)=CO(k−1)+K1*[SP(k)−PV(k)]*T−K2*[PV(k)−PV(k−1)], which is also called a PI controller, etc.

5. An MIMO PID controller of claim 4, wherein the remaining PID parameters are obtained by using an optimization algorithm which minimizes the largest modulus of all poles of the discrete time closed loop transfer function from said SP to said PV.

6. An MIMO PID controller of claim 5, wherein the said optimization algorithm is a constrained optimization algorithm which minimizes the largest modulus of all poles of the discrete time closed loop transfer function from said SP to said PV and at the same time guarantees that the user prescribed constraints on the PID parameters are satisfied.

7. A PID controller of claim 1, wherein said PV, said SP, said CO, and said PID parameters are all scalars, and m=n=1.

8. A PID controller of claim 2, wherein said PV, said SP, said CO, and said PID parameters are all scalars, and m=n=1.

9. A PID controller of claim 3, wherein said PV, said SP, said CO, and said PID parameters are all scalars, and m=n=1.

10. A PID controller of claim 4, wherein said PV, said SP, said CO, and said PID parameters are all scalars, and m=n=1.

11. A PID controller of claim 5, wherein said PV, said SP, said CO, and said PID parameters are all scalars, and m=n=1.

12. A PID controller of claim 6, wherein said PV, said SP, said CO, and said PID parameters are all scalars, and m=n=1.

13. A method of finding the optimal PID parameters for any traditional independent or dependent form of PID controllers by using a qualified minimax algorithm that minimizes the largest modulus of all poles of the discrete time closed loop transfer function from set point SP to process variable PV.

14. A method of claim 13, wherein the minimax algorithm is a constrained minimax algorithm which minimizes the largest modulus of the discrete time closed loop transfer function from said SP to said PV and at the same time guarantees that all PID parameters are within their admissible ranges.
